(19) United States
(12) Patent Application Publication
(10) Pub. No.: US 2020/0263728 A1
(43) Pub. Date: Aug. 20, 2020

(54) INTERCONNECTABLE LOCKING MODULES

(71) Applicant: GM Global Technology Operations LLC, Detroit, MI (US)

(72) Inventors: Kamil Balcerzak, Royal Oak, MI (US); Zachary E. Cox, Sterling Heights, MI (US); Dylan J. Jarjis, Troy, MI (US); Rebecca Cooke, Madison Heights, MI (US)

(21) Appl. No.: 16/277,435

(22) Filed: Feb. 15, 2019

(51) Int. Cl. F16C 11/06; F16M 13/02

(52) U.S. Cl. CPC F16C 11/0623; F16M 2200/021; F16M 13/022

(57) ABSTRACT

An interconnectable locking module having a first portion including an external surface defining a bulbous connector extending along a longitudinal axis; a second portion opposite of the first portion, the second portion includes an interior surface defining a hollow receptacle, and an opposite exterior surface defining a circumferential flange having a tapered channel. The tapered channel includes a channel opening and an opposite closed end. The module also includes a locking ring having an interior circumferential surface insertable over the bulbous connector and engageable with the circumferential flange. The locking ring includes a tab insertable into the channel opening and slidable against a tapered channel surface. A plurality of interconnectable locking module may be joined in series to provide an assembly such as a physical model representing a prototype conduit or a path for a conduit.

### INTRODUCTION

The present disclosure relates to interconnectable modules, and more particularly to interconnectable locking modules.

Interconnectable modules, such as small plastic toy blocks having interlocking features, are known in the art. Examples of such interconnectable modules are interconnectable building blocks, where each module is compatible with other modules in such a way that the individual modules may be interconnected to form an assembly representing a structure. These interconnectable modules may also be used in practical applications. Examples of such practical applications include, but are not limited to, the building of three-dimensional representations of mechanical components for prototyping purposes and the building of useable structures such as a cradle or a holder for a personal electronic device.

Interconnectable modules are adequate for building small compact structures, however, these interconnectable modules do not have a mean to be securely locked together once assembled. Thus, especially for elongated structures, the interconnected modules have a tendency to disconnect from each other under its own weight. Furthermore, once the interconnectable modules are assembled, the structures are not readily articulable.

While such interconnectable modules are generally satisfactory for their intended purpose, there exist a need for interconnectable modules that are conducive for forming elongated structures, selectively articulable, and lockable to maintain the structure's integrity.

### SUMMARY

An interconnectable locking module is disclosed. The interconnecting locking module includes a first portion having an external surface defining a bulbous connector extending along a longitudinal axis; a second portion opposite of the first portion, the second portion includes an interior surface defining a hollow receptacle and an opposite exterior surface defining a circumferential flange having a tapered channel including a channel opening and an opposite closed end; and a locking ring having an interior circumferential surface insertable over the bulbous connector and engageable with the circumferential flange. The locking ring includes a tab insertable into the channel opening and through the tapered channel to the closed end.

In an additional aspect of the present disclosure, the tapered channel includes an axial extending channel segment including the channel opening oriented toward the first portion and a circumferential extending channel segment including the closed end.

In another aspect of the present disclosure, the tapered channel includes a shallower second depth (H2) adjacent the closed end tapering to the deeper first depth (H1) adjacent the channel opening.

In another aspect of the present disclosure, the external surface of the first portion further defines a plurality of recessed channels extending in the direction of the longitudinal axis on the bulbous connector.

In another aspect of the present disclosure, the interior surface of the second portion further defines a plurality of protruding ribs corresponding with the plurality of recessed channels on the bulbous connector.

In another aspect of the present disclosure, the plurality of recess channels includes a width (W1) and the plurality of protruding ribs include a width of (W2) narrower than (W1).

In another aspect of the present disclosure, the external surface of the first portion further defines an opening about the longitudinal axis on a first distal end of the bulbous connector.

In another aspect of the present disclosure, the interior surface of the second portion further defines an interior passageway in fluid communication with the opening of the bulbous connector.

In another aspect of the present disclosure, the second portion includes an edge surface interconnecting the exterior surface of the second portion and the interior surface of the second portion, the edge surface defines a slot having an open slot end.

In another aspect of the present disclosure, the interconnectable locking module further includes intermediate portion integrally connecting the first portion to the second portion, the intermediate portion includes diameter less that a diameter of the bulbous connector and less than a diameter of the circumferential flange.

According to several aspects, an interconnectable locking module system is disclosed. The interconnectable locking module system includes a first interconnectable module comprising a spherical connector having one of (i) a plurality of axially extending protruding ribs and (ii) a plurality of axially extending recessed channels; and a second interconnectable module comprising a socket receptacle configured to receive the spherical connector of the first module, wherein the socket receptacle comprises the other of (i) the plurality of axially extending protruding ribs and (ii) the plurality of axially extending recessed channels. The axially extending recessed channel are configured to receive the protruding ribs to restrict the axial rotation of the first interconnectable module with respect to the second interconnectable module.

In an additional aspect of the present disclosure, the axially extending recessed channel are configured to cooperate with the protruding ribs to allow for the angular movement of the second interconnectable module with respect to the first interconnectable module.

In another aspect of the present disclosure, the second interconnectable module further includes a circumferential flange and a tapered channel defined in an external surface of the circumferential flange. The tapered channel includes a channel opening and an opposite closed end.

In another aspect of the present disclosure, the interconnectable locking module system further includes a locking ring having an interior circumferential surface engageable with the external surface of the circumferential flange. The locking ring includes a tab insertable into tapered channel through the open end of the channel.

In another aspect of the present disclosure, the circumferential flange includes an edge surface defining an axial slot having an open end.

In another aspect of the present disclosure, first interconnectable module is standardized with the second interconnectable module such that both first and second interconnectable modules are substantially identical.

According to several aspects, an interconnectable locking module assembly is disclosed. The interconnectable locking module assembly includes a plurality of interconnectable locking modules interconnected in series. Each interconnectable locking module includes a spherical connector and an opposite socket receptacle configured to receive the spherical connector of an adjoining interconnectable locking module. Each socket receptacle includes an internal surface defining a plurality of the axially extending protruding ribs. Each spherical connector includes an external surface defining a plurality of axially extending recessed channels configured to receive the axially extending protruding ribs of the adjoining interconnectable locking module.

In an additional aspect of the present disclosure, the interconnectable locking module assembly further includes a locking ring configured to secure the socket receptacle to the spherical connector of two adjoining interconnectable locking modules. Each socket receptacle includes a circumferential flange and a tapered channel defined in an external surface of the circumferential flange. The tapered channel includes a closed end tapering toward a channel opening. The locking ring includes an interior circumferential surface engageable to the circumferential flange. The locking ring includes a tab insertable into channel opening and slidable engageable with the tapered channel from the open end to the closed end.

In another aspect of the present disclosure, the interconnectable locking module assembly defines a physical model representing a path for a conduit through a compartment of a vehicle.

In another aspect of the present disclosure, the interconnectable locking module assembly further includes a first end interconnectable module having a mount configured to retain a personal electronic device and a second end interconnectable module having a base plate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side-view of an interconnectable locking module, according to an exemplary embodiment;

FIG. 2 is a perspective end view of the interconnectable locking module of FIG. 1, according to an exemplary embodiment;

FIG. 3 is a locking ring for the interconnectable locking module of FIG. 1, according to an exemplary embodiment;

FIG. 4 is an end-view of the interconnectable locking module of FIG. 1, according to an exemplary embodiment;

FIG. 5 is an assembly of interconnectable locking modules extending in a direction of a longitudinal axis;

FIG. 6 is an assembly of interconnectable locking modules extending in a direction at an angle to the longitudinal axis;

FIG. 7 is a view of an engine compartment of a motor vehicle having a first assembly of interconnectable locking modules modeling a routing path; and

FIG. 8 is a side-view of a second assembly of interconnectable locking modules defining an electronic device holder.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

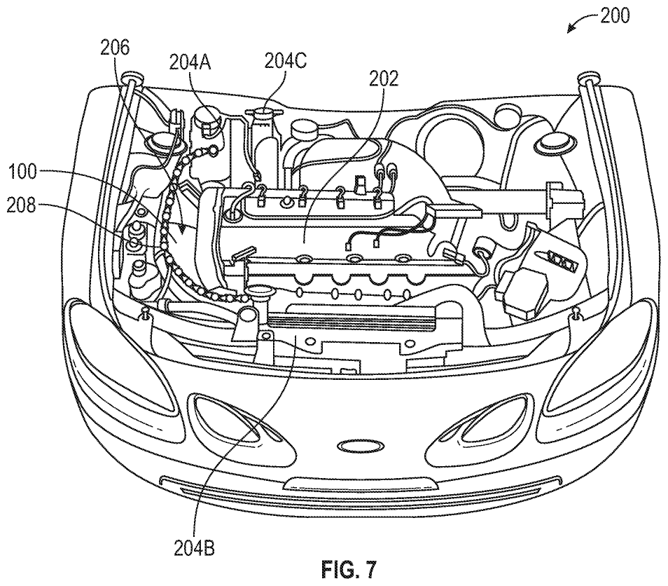

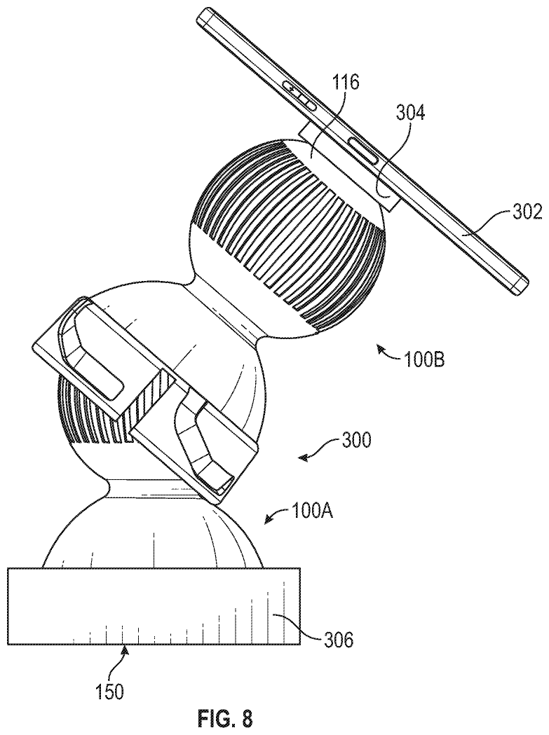

FIG. 1 shows a side-view of an interconnectable locking module 100 extending along a longitudinal axis-A. A series of standardized interconnectable locking module 100 may be assembled where a first portion 102 of one interconnectable locking module 100 is inserted into a second portion 104 of another interconnectable locking module 100 to define various assemblies that may offer multiple beneficial uses. Standardized interconnectable locking module 100 means interconnectable locking modules 100 having substantially the same shape, size, and features. Examples of such assemblies are shown in FIG. 7 and FIG. 8 and are discussed in detail below. The shape of the assemblies may be fixed by locking adjoined interconnectable locking modules 100 with a locking ring 106.

Referring to FIG. 1, the interconnectable locking module 100 includes a first portion 102, a second portion 104 opposite of the first portion 102, and an intermediate portion 108 integrally connecting the first portion 102 with the second portion 104. The interconnectable locking module 100 is shown extending along a longitudinal axis-A. The first portion 102 includes an external surface 110 defining a bulbous connector 112, preferably having an external spherical shape. The external surface 110 further defines an opening 114 at a first distal end 116 of the bulbous connector 112. The opening 114 is shown as having a circular shape and is concentrically located about the axis-A. The external surface 110 further defines a plurality of recessed channels 118 extending in the direction of the axis-A. The plurality of recessed channels 118 are equally spaced about the axis-A. Each of the recessed channels 118 includes a predetermined width (W1).

FIG. 2 shows a perspective end-view of the interconnectable locking module 100. Referring to both FIG. 1 and FIG. 2, the second portion 104 includes an interior surface 120 defining a hollow receptacle 122, also referred to as a socket 122. The interior surface 120 further defines a plurality of protruding ribs 124 extending in a direction along the axis-A. The distribution of the plurality of protruding ribs 124 about the axis-A corresponding with the distribution of the recessed channels 118 on the bulbous connector 112 and includes a width (W2). The width W2 is less than the width (W1) such that the protruding ribs 124 of the bulbous connector 112 are receivable within the recessed channels 118 of a hollow receptacle 122 122 of adjoining interconnectable locking module 100. The interior surface 120 further defines an interior passageway 126 extending through the intermediate portion 108 and in fluid communication with the opening 114 through the bulbous connector 112.

Best shown in FIG. 1, the second portion 104 includes an exterior surface 128 defining a circumferential flange 130 facing away from the longitudinal axis-A. The circumferential flange 130 includes a length (L) extending in a direction along the longitudinal axis-A and a plurality of tapered channels 132. Each of the tapered channel includes an axial extending channel segment 134 having a channel opening 136. The axial extending segment 134 transitions into a circumferential extending channel segment 138 having a closed end 140 opposite the channel opening 136. Best shown in FIG. 2, the taper channel includes a first depth (H1) as measured from a circumferential flange surface 142 to a tapered channel surface 143 adjacent the channel opening 136 and a second depth (H2) as measured from the circumferential flange 142 surface to a tapered channel surface 143 adjacent the closed end 140. The first depth (H1) is greater than the second depth (H2). The tapered channel surface 143 gradually transitions from first depth (H1) adjacent the channel opening 136 to the shallower second depth (H2) adjacent the closed end 140.

The second portion 104 also includes an edge surface 144 144 interconnecting the circumferential flange 142 surface with the interior surface of the second portion 104. The edge surface 144 defines a slot 146 having a slot open end 148 at a second distal end 150 of the interconnectable locking module 100, where the second distal end 150 is opposite the first distal end 116.

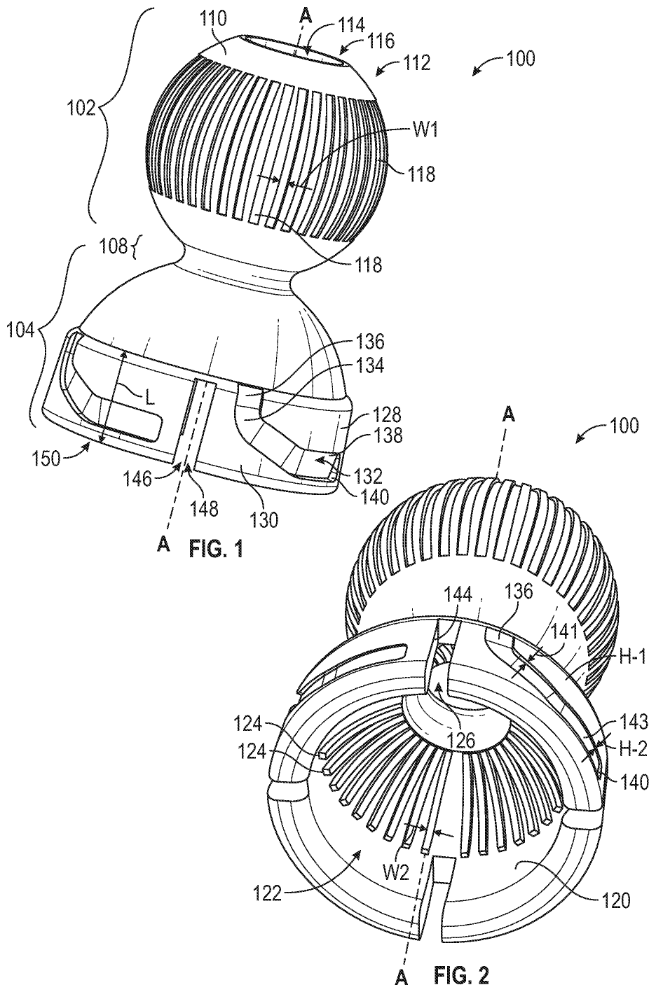

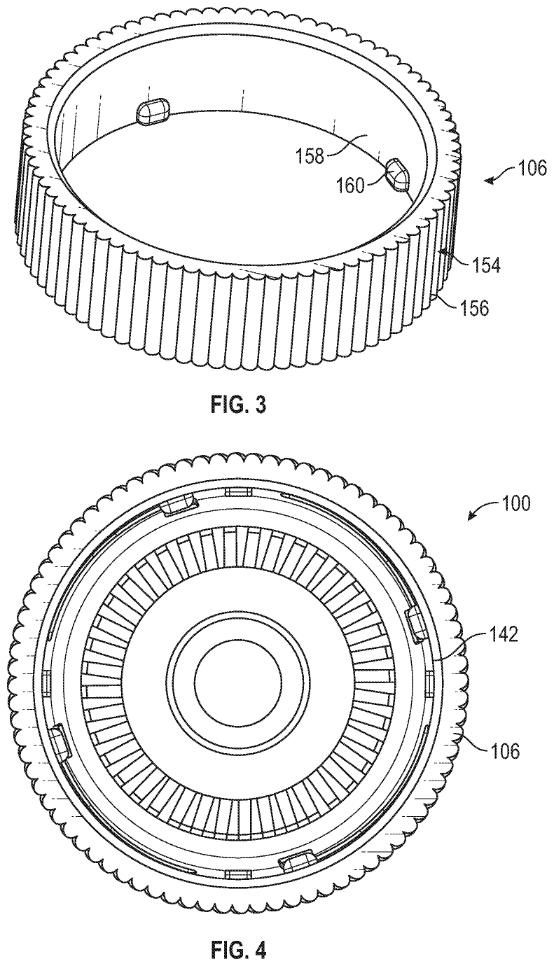

FIG. 3 shows a locking ring 106 for the interconnectable locking module 100 and FIG. 4 shows an end-view of the interconnectable locking module 100 having the locking ring 106 engaged to the circumferential flange surface 142. The locking ring 106 includes an exterior surface 154 defining a plurality of axially extending ridges 156 and interior circumferential surface 158 having a plurality of tabs 160 radially extending toward the axis-A. The number of tabs 160 corresponds with the number of tapered channels 132 on the circumferential flange 130. The locking ring 106 is sized such that the interior circumferential surface 158 of the locking ring 106 is engageable with the circumferential flange surface 142 and the taps 160 are insertable into the channel openings 136.

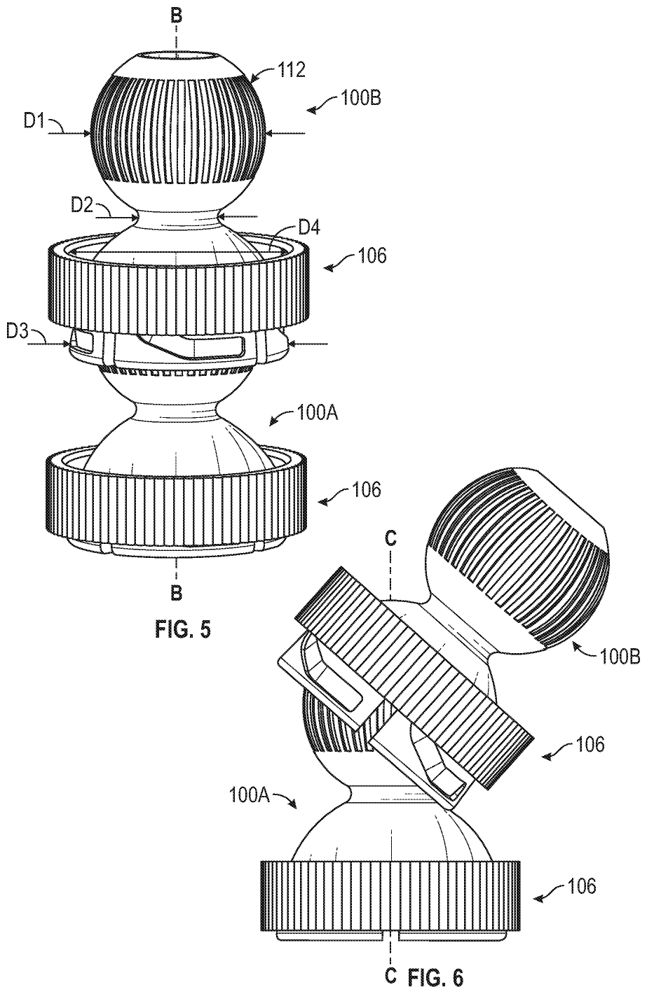

FIG. 5 shows an assembly of a first interconnectable locking module 100A and a second interconnectable locking module 100B extending in a direction of a longitudinal axis-B. FIG. 6 shows an assembly of the second interconnectable locking module 100B extending in a direction at an angle relative to the longitudinal axis-C extending through the first interconnectable locking module 100A. The bulbous connector 112 includes a first exterior diameter (D1), the intermediate portion 108 includes a second exterior diameter (D2), the hollow receiver includes a third exterior diameter (D3), and the ring includes a fourth interior diameter (D4). D2 is less than either of D1, D3, and D4; D1 is less than the D3 and D4, and the D3 is less than the D4.

The bulbous connector 112 of the first interconnectable locking module 100A is inserted, or snapped on, into the hollow receptacle 122 of the second interconnectable locking module 100B, such that the protruding ribs 124 of the second interconnectable locking module 100B are aligned and received in the recessed channels 118 of the first interconnectable locking module 100A. The locking ring 106 is inserted axially over the bulbous connector 112 and onto the circumferential flange surface 142 with the tabs 160 aligned with the corresponding channel openings 136 of the tapered channels 132. Once the tabs 160 are inserted into the tapered channels 132, the locking ring 106 is axially rotated such that the tabs 160 rides on the tapered channel surface thereby urging the circumferential flange 142 radially inwardly thus securing the hollow receptacle 122 to the bulbous connector 112.

The interconnectable locking module 100, including the locking ring 106, may be formed of a compliant plastic composite material by 3-D printing or plastic injection molding. The interconnectable locking module 100, including the locking ring 106, may also be formed of a compliant metallic alloy by hot injection molding or casting.

FIG. 7 shows an engine compartment 200 of a vehicle have an engine 202 and plurality of vehicle components 204A-C such as a windshield washer reservoir, radiator, brake fluid reservoir, etc. defining open space 206 between the vehicle components 204. A plurality of standardized interconnectable locking modules 100 are assembled in series to form a physical model 208 of a path to route a vehicle conduit through the engine compartment 200. The vehicle conduit may be that of a length of a wiring harness, an engine coolant line, a refrigerant coolant line, or any other conduit that may be found in an engine compartment 200. The physical model 208 of the path is locked in position with locking rings 106 between adjacent connected interconnectable locking modules 100. The physical model 208 may be minimally disassembled in one or more sections by removing selective locking rings 106 and removing the minimally disassembled physical model 208 from the engine compartment 200. Once removed from the engine compartment 200, the physical model 208 may be reassembled and used to as a pattern for the measuring and/or manufacturing of a prototype conduit. It should be appreciated that the physical model 208 may be selectively disassembled and reconfigured as desired.

For this application, it is preferable that D1 is in a range of approximately 9 to 11 mm, D2 is in a range of approximately 5 to 7 mm, D3 is in a range of 21 to 23 mm, D4 is in a range of 21 to 23 mm, and L is approximately 7 mm. It is understood that these ranges are not meant to be limiting and the interconnectable locking modules 100 may be scaled up or scaled down to meet the needs of the particular application.

FIG. 8 shows a first interconnectable locking module 100A interconnected with a second interconnectable locking module 100B to form a mount assembly 300 for a personal electronic device 302 such as a cell phone or a small table. The mount assembly 300 includes the second interconnectable locking module 100B having a permanent magnet or cradle 304 affixed to the first distal end 116 and first interconnectable locking module 100A having a base plate 306 affixed to the second distal end 150. The first interconnectable locking module 100 is locked to the second interconnectable locking module 100B with the locking ring 106. The protruding ribs defined in the hollow receptacle of the second interconnectable module 100B cooperates with the recessed channels defined in the bulbous connector of the first interconnectable module 100A to allow for the tilting of the second interconnectable module 100B relative to the first interconnectable module 100A, but restricts the relative rotation of the first and second interconnectable modules 100A, 1006. While only two interconnectable locking modules 100A, 100B are shown, it should be appreciated that the mount assembly 300 may include multiple interconnectable locking modules 100 assembled between the first interconnectable locking module 100A and the second interconnectable locking module 1006 without departing from the scope of the invention.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An interconnectable locking module, comprising:
a first portion having an external surface defining a bulbous connector extending along a longitudinal axis;
a second portion opposite of the first portion, the second portion including an interior surface defining a hollow receptacle, and an opposite exterior surface defining a circumferential flange having a tapered channel including a channel opening and an opposite closed end; and
a locking ring having an interior circumferential surface insertable over the bulbous connector and engageable with the circumferential flange, wherein the locking ring includes a tab insertable into the channel opening and through the tapered channel to the closed end.

2. The interconnectable locking module of claim 1, wherein the tapered channel includes an axial extending channel segment including the channel opening oriented toward the first portion and a circumferential extending channel segment including the closed end.

3. The interconnectable locking module of claim 2, wherein the tapered channel includes a shallower second depth (H2) adjacent the closed end tapering to a deeper first depth (H1) adjacent the channel opening.

4. The interconnectable locking module of claim 1, wherein the external surface of the first portion further defines a plurality of recessed channels extending in a direction of the longitudinal axis on the bulbous connector.

5. The interconnectable locking module of claim 4, wherein the interior surface of the second portion further defines a plurality of protruding ribs corresponding with the plurality of recessed channels on the bulbous connector.

6. The interconnectable locking module of claim 5, wherein the plurality of recessed channels includes a width (W1) and the plurality of protruding ribs include a width of (W2) narrower than W1.

7. The interconnectable locking module of claim 1, wherein the external surface of the first portion further defines an opening about the longitudinal axis on a first distal end of the bulbous connector.

8. The interconnectable locking module of claim 7, wherein the interior surface of the second portion further defines an interior passageway in fluid communication with the opening of the bulbous connector.

9. The interconnectable locking module of claim 1, wherein the second portion includes an edge surface interconnecting the exterior surface of the second portion and the interior surface of the second portion, the edge surface defines a slot having an open slot end.

10. The interconnectable locking module of claim 1, further comprising an intermediate portion integrally connecting the first portion to the second portion, the intermediate portion includes a diameter less that a diameter of the bulbous connector and less than a diameter of the circumferential flange.

11. An interconnectable locking module system, comprising:
a first interconnectable module comprising a spherical connector having one of (i) a plurality of axially extending protruding ribs and (ii) a plurality of axially extending recessed channels;
a second interconnectable module comprising a socket receptacle configured to receive the spherical connector of the first interconnectable module, wherein the socket receptacle comprises the other of (i) the plurality of axially extending protruding ribs and (ii) the plurality of axially extending recessed channels;
wherein the axially extending recessed channel are configured to receive the protruding ribs to restrict a axial rotation of the first interconnectable module with respect to the second interconnectable module.

12. The interconnectable locking module system of claim 11, wherein the axially extending recessed channel are configured to cooperate with the protruding ribs to allow for an angular movement of the second interconnectable module with respect to the first interconnectable module.

13. The interconnectable locking module system of claim 12, wherein the second interconnectable module further comprising:
a circumferential flange; and
a tapered channel defined in an external surface of the circumferential flange, wherein the tapered channel includes a channel opening and an opposite closed end.

14. The interconnectable locking module system of claim 13, further comprising a locking ring having an interior circumferential surface engageable with the external surface of the circumferential flange, the locking ring includes a tab insertable into the tapered channel through the open end of the tapered channel.

15. The interconnectable locking module system of claim 14, wherein the circumferential flange includes an edge surface defining an axial slot having an open end.

16. The interconnectable locking module system of claim 15, wherein the first interconnectable module is standardized with the second interconnectable module such that both first and second interconnectable modules are substantially identical.

17. An interconnectable locking module assembly comprising:
a plurality of interconnectable locking modules interconnected in series;
wherein each interconnectable locking module includes a spherical connector and an opposite socket receptacle configured to receive the spherical connector of an adjoining interconnectable locking module;
wherein each socket receptacle includes an internal surface defining a plurality of the axially extending protruding ribs; and
wherein each spherical connector includes an external surface defining a plurality of axially extending recessed channels configured to receive the axially extending protruding ribs of the adjoining interconnectable locking module.

18. The interconnectable locking module assembly of claim 17, further comprising a locking ring configured to secure the socket receptacle to the spherical connector of two adjoining interconnectable locking modules;
wherein each socket receptacle includes a circumferential flange and a tapered channel defined in an external surface of the circumferential flange, wherein the tapered channel includes a closed end tapering toward a channel opening; and
wherein the locking ring includes an interior circumferential surface engageable to the circumferential flange, the locking ring includes a tab insertable into channel opening and slidable engageable with the tapered channel from the open end to the closed end.

19. The interconnectable locking module assembly of claim 18 defines a physical model representing a path for a conduit through a compartment of a vehicle.

20. The interconnectable locking module assembly of claim 18 further comprises a first end interconnectable module having a mount configured to retain a personal electronic device and a second end interconnectable module having a base plate.
